(19) United States
(12) Patent Application Publication
(10) Pub. No.: US 2020/0400490 A1
(43) Pub. Date: Dec. 24, 2020

(54) THERMOELECTRIC LASER POWER PROBE AND MANUFACTURING METHOD THEREOF

(71) Applicant: ShenZhen CaiHuang Thermoelectricity Technology Co., Ltd., Shenzhen (CN)

(72) Inventors: Ping Fan, Shenzhen (CN); Tianbao Chen, Shenzhen (CN); Zhaokun Cai, Shenzhen (CN); Chaoming Chen, Shenzhen (CN); Zhuanghao Zheng, Shenzhen (CN); Guangxing Liang, Shenzhen (CN)

(21) Appl. No.: 17/012,117

(22) Filed: Sep. 4, 2020

Related U.S. Application Data
(63) Continuation of application No. PCT/CN2018/090451, filed on Jun. 8, 2018.

(30) Foreign Application Priority Data
Mar. 7, 2018 (CN) 201810184299.9

(51) Int. Cl. G01J 1/42; G01J 5/06; G01J 5/08; G01J 5/12

(52) U.S. Cl. CPC G01J 1/4257; G01J 5/06; G01J 2005/123; G01J 5/12; G01J 5/0853

(57) ABSTRACT

Embodiments of the present disclosure provide a thermoelectric laser power probe, including a heat dissipation housing and a laser power probing unit fixed inside the heat dissipation housing. The heat dissipation housing is provided with a light inlet. The laser power probing unit includes a substrate. The substrate includes a top surface and at least two outer side surfaces. The top surface is provided with an absorbent material layer. The absorbent material layer corresponds to the light inlet. The at least two outer side surfaces are symmetrically arranged about a center line of a cross section of the top surface, each of the outer side surfaces is perpendicular to the top surface or a tangent plane of the top surface, and each of the outer side surfaces is sequentially provided with an insulating layer and a thin-film thermopile.

### CROSS-REFERENCE TO RELATED APPLICATIONS

This application is a continuation of International Patent Application No. PCT/CN2018/090451, filed on Jun. 8, 2018, which is based upon and claims priority to Chinese Patent Application No. 201810184299.9, filed with the Chinese Patent Office on Mar. 7, 2018, and entitled “THERMOELECTRIC LASER POWER PROBE AND MANUFACTURING METHOD THEREOF”, the entire contents of which are incorporated herein by reference.

### TECHNICAL FIELD

The present disclosure relates to the technical field of laser measurements, and in particular, relates to a thermoelectric laser power probe and a manufacturing method thereof.

### BACKGROUND

With the developments of laser technologies, lasers are being more and more widely applied in the fields such as communications, medical devices, industrial manufacturing, and the like. During research, production, and application of the lasers, measurement and calibration of power of the lasers are indispensable. Laser power probes are categorized into thermoelectric probes and photoelectric diode-type probes according to the principles and materials thereof.

The photoelectric diode-type laser power probes have a high response speed and a high response frequency, but are limited to some wavelengths during application. For example, a Si photoelectric diode-type probe is only capable of measuring light having a wavelength within 1 micrometer, and is more suitable for measuring lasers having a small power. For example, such probes are capable of directly detecting lasers having a power of 1 pW to hundreds of mW, and after a filter having a specific wavelength is added, the probes are capable of measuring lasers having a power within 3 W.

Traditional thermoelectric laser power probes, due to large numbers of types of absorbent materials which correspond to different absorption spectrums and different power density damage thresholds, may be applicable to ultraviolet to far infrared wavelength bands. Such probes achieve a large measurement range, from the order of mW to the order of kW. During measurement of continuous laser irradiation, when a laser source irradiates a detector target of a thermopile, the generated heat is converted into a potential by the detector, and is spread along a passive region towards an edge. In this way, a potential difference is caused between a hot end and a cold end of the thermopile, which is finally read by a voltage meter.

### SUMMARY

The embodiments of the present disclosure provide a thermoelectric laser power probe, the thermoelectric laser power probe includes a heat dissipation housing and a laser power probing unit fixed inside the heat dissipation housing, and the heat dissipation housing is provided with a light inlet;

wherein the at least two outer side surfaces are symmetrically arranged about a center line of a cross section of the top surface, each of the outer side surfaces is perpendicular to the top surface or a tangent plane of the top surface, and each of the outer side surfaces is sequentially provided with an insulating layer and a thin-film thermopile;

the thin-film thermopile includes at least two thin-film thermocouples, two adjacent thin-film thermocouples are electrically connected by a connection junction, each of the thin-film thermocouples includes a PN junction, the PN junction being located at one end proximal to the top surface of the substrate, the connection junction being located at the other end opposite to the top surface of the substrate, and one end where the PN junction is located is an operating end, one end where the connection junction is located is a reference end.

Another embodiment of the present disclosure provides a manufacturing method of the above thermoelectric laser power probe, the manufacturing method includes the following steps:

S1, providing a substrate comprising a top surface and at least two outer side surfaces, wherein the at least two outer side surfaces are symmetrically arranged about a center line of a cross section of the top surface, and each of the outer side surfaces is perpendicular to the top surface or a tangent plane of the top surface;

S2, preparation of an absorbent material layer: preparing the absorbent material layer on the top surface of the substrate;

S3, preparation of an insulating layer: preparing the insulating layer on each of the outer side surfaces of the substrate;

S4, preparation of a thin-film thermopile: preparing the thin-film thermopile on the insulating layer by a thin-film deposition process, and leading out positive and negative electrodes on the thin-film thermopile;

S5, preparation of a laser power probing unit: leading out output conductive wires of the laser power probing unit on the positive and negative electrodes of the thin-film thermopile respectively, wherein the thin-film thermopiles located on different insulating layers are connected in series to form the laser power probing unit of the thermoelectric laser power probe; and

S6, packaging of a heat dissipation housing: fixing the laser power probing unit inside the heat dissipation housing, and adding a highly thermally conductive medium between the laser power probing unit and the heat dissipation housing to form the thermoelectric laser power probe.

### BRIEF DESCRIPTION OF THE DRAWINGS

For clearer descriptions of the technical solutions according to the embodiments of the present disclosure, hereinafter brief description is given with reference to the accompanying drawings for illustrating the embodiments. Apparently, the accompanying drawings described hereinafter only illustrate some embodiments of the present disclosure, and other accompanying drawings may also be derived based on these accompanying drawings.

FIG. 1 is a sectional view of a thermoelectric laser power probe according to a first embodiment of the present disclosure;

FIG. 2 is a top view of the thermoelectric laser power probe as illustrated in FIG. 1;

FIG. 3 is a schematic sectional view of a laser power probing unit according to the first embodiment of the present disclosure;

FIG. 4 is a schematic structural view of a thin-film thermopile according to the first embodiment of the present disclosure;

FIG. 5 is a schematic structural view of a thin-film thermopile having a multi-layer film structure according to a second embodiment of the present disclosure;

FIG. 6 is a schematic sectional view of a substrate of a laser power probing unit according to a third embodiment of the present disclosure;

FIG. 7 is a schematic sectional view of a laser power probing unit according to a fourth embodiment of the present disclosure; and

FIG. 8 is flowchart of a manufacturing method of a thermoelectric laser power probe according to a fifth embodiment of the present disclosure.

### DETAILED DESCRIPTION

For better understanding of the present disclosure, the present disclosure is described in detail with reference to attached drawings and specific embodiments. It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element, or one or more centered elements may be present therebetween. As used herein, the terms “vertical”, “horizontal”, “left”, “right”, and similar expressions are for illustration purposes.

Unless the context clearly requires otherwise, throughout the specification and the claims, technical and scientific terms used herein denote the meaning as commonly understood by a person skilled in the art. Additionally, the terms used in the specification of the present disclosure are merely for description the embodiments of the present disclosure, but are not intended to limit the present disclosure. In addition, technical features involved in various embodiments of the present disclosure described hereinafter may be combined as long as these technical features are not in conflict.

### First Embodiment

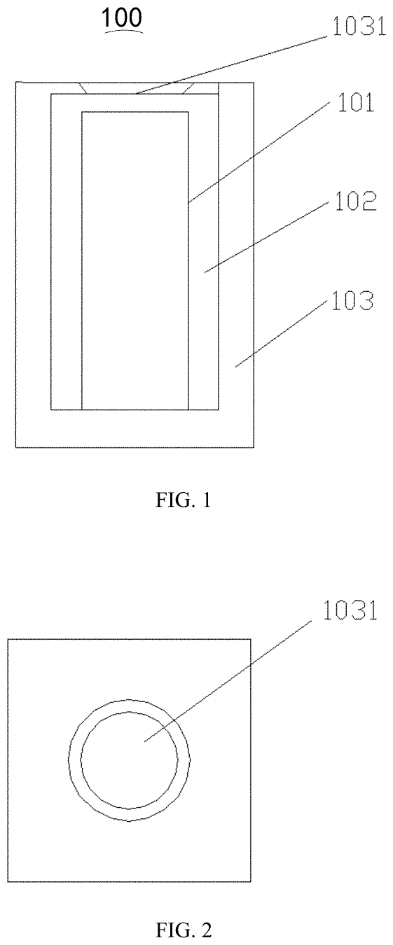

Referring to FIG. 1 and FIG. 2, FIG. 1 is a sectional view of a thermoelectric laser power probe according to a first embodiment of the present disclosure; and FIG. 2 is a top view of the thermoelectric laser power probe. As illustrated in FIG. 1 and FIG. 2, the thermoelectric laser power probe 100 includes: a heat dissipation housing 103 and a laser power probing unit 101 fixed inside the heat dissipation housing 103, wherein the heat dissipation housing 103 is provided with a light inlet 1031.

Optionally, the thermoelectric laser power probe 100 further includes: a thermally conductive layer 102 located between the heat dissipation housing 103 and the laser power probing unit 101. The thermally conductive layer 102 is made of a highly thermally conductive medium. By arranging the thermally conductive layer 102 between the heat dissipation housing 103 and the laser power probing unit 101, the laser power probing unit 101 may be in good contact with a contact end of the heat dissipation housing 103.

In another embodiment, an outer peripheral edge of the heat dissipation housing 103 is provided with heat dissipation leaves (not illustrated in the drawings) for good heat dissipation.

The laser power probing unit 101 includes a substrate, wherein the substrate includes a top surface and at least two outer side surfaces. The top surface is provided with an absorbent material layer, wherein the absorbent material layer corresponds to the light inlet 1031, and is configured to absorb laser and convert laser energy into heat.

The at least two outer side surfaces are symmetrically arranged about a center line of a cross section of the top surface, each of the outer side surfaces is perpendicular to the top surface or a tangent plane of the top surface, and each of the outer side surfaces is sequentially provided with an insulating layer and a thin-film thermopile. The absorbent material layer located on the top surface absorbs laser and convert laser energy into heat, and the heat is spread in a direction parallel to a laser incident direction.

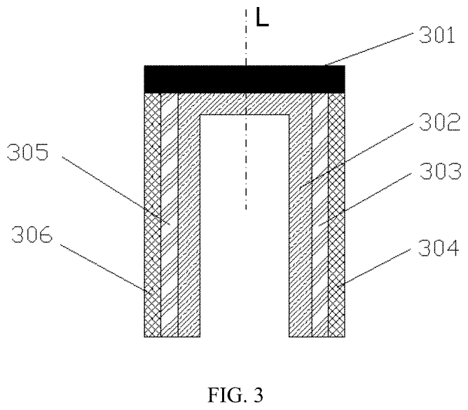

In this embodiment, the laser power probing unit 101 is a gate-shaped structure. Referring to FIG. 3, FIG. 3 is a schematic sectional view of the laser power probing unit 101. As illustrate in FIG. 3, the laser power probing unit 101 includes: an absorbent material layer 301, a substrate 302, insulating layers (a first insulating layer 303 and a second insulating layer 305), and thin-film thermopiles (a first thin-film thermopile 304 and a second thin-film thermopile 306).

Specifically, the substrate 302 is a gate-shaped substrate, and includes a horizontal top surface and two outer side surfaces. The top surface is provided with the absorbent material layer 301. The absorbent material layer 301 corresponds to the light inlet 1301. The two outer side surfaces are symmetrically arranged about a center line L of a cross section of the top surface, and each of the outer side surfaces is perpendicular to the top surface.

Exemplarily, the first insulating layer 303 and the second insulating layer 305 are respectively located on the two outer side surfaces of the substrate 302, the first thin-film thermopile 304 is located on the first insulating layer 303, and the second thin-film thermopile 306 is located on the second insulating layer 305. The first insulating layer 303 and the second insulating layer 305 are also symmetrically arranged about the center line L of the cross section of the top surface. The first thin-film thermopile 304 and the second thin-film thermopile 306 are also symmetrically arranged about the center line L of the cross section of the top surface.

The absorbent material layer 301 is configured to absorb laser and convert laser energy into heat, and may include a surface absorbent material or a body absorbent material. Different absorbent materials may be used depending on different power ranges and different laser types. Optionally, the absorbent material layer 301 has a thickness of 1 nm to 3 mm. In some exemplary embodiment, the absorbent material layer 301 has an area that is greater than or equal to an area of the top surface.

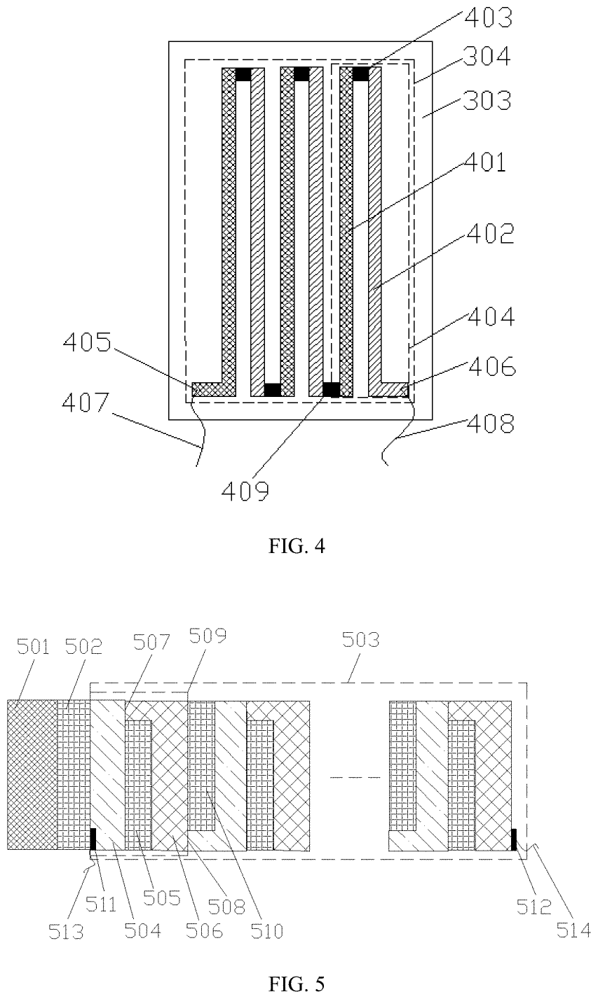

Still referring to FIG. 4, FIG. 4 is a schematic structural view of a thin-film thermopile. As illustrated in FIG. 4, the thin-film thermopile includes a plurality of thin-film thermocouples 404 connected in series. Two adjacent thin-film thermocouples 404 are electrically connected by a connection junction 409.

Each of the thin-film thermocouples 404 includes a P-type thermocouple layer 401 and an N-type thermocouple layer 402. The P-type thermocouple layer 401 and the N-type thermocouple layer 402 are superimposed upon each other at one end proximal to the top surface of the substrate 302 to form a PN junction 403. One end where the PN junction 403 is located is an operating end, and the other end opposite to the operating end is a reference end. The connection junction 409 is located at the reference end, and the thermocouple layers connected by the connection junction 409 are in different types. In this way, the thin-film thermopile is consistent with a laser incident direction.

In practice, the P-type thermocouple layer 401 and the N-type thermocouple layer of the adjacent thin-film thermocouple are superimposed upon each other at one end distal from the top surface of the substrate 302 to form the connection junction 409, and the N-type thermocouple layer 402 and the P-type thermocouple layer of the adjacent thin-film thermocouple are superimposed upon each other at the end distal from the top surface of the substrate 302 to form the connection junction 409.

A positive electrode 405 of the thin-film thermopile is led out from the reference end of the P-type thermocouple layer 401 of one outermost thin-film thermocouple 404, a negative electrode 406 of the thin-film thermopile is led out from the reference end of the N-type thermocouple layer 402 of another outermost thin-film thermocouple 404, and output conductive wires 407 and 408 of the entire thin-film thermopile are respectively led out from the positive electrode 405 and the negative electrode 406 by welding or contact connection.

The thin-film thermopiles located on different insulating layers are connected in series by the output conductive wires 407 and 408, such that the output conductive wires of the entire laser power probing unit 101 are led out.

The P-type thermocouple layer 401 includes, but not limited to, a P-type Te-substrate thermoelectric thin-film layer, a Zn-substrate thermoelectric thin-film layer, or the like thermoelectric thin-film material layer.

The N-type thermocouple layer 402 includes, but not limited to, a N-type Te-substrate thermoelectric thin-film layer, a Zn-substrate thermoelectric thin-film layer, or the like thermoelectric thin-film material layer.

Optionally, the P-type thermocouple layer 401 has a thickness of 1 nm to 10.0 μm. In some exemplary embodiments, the thickness may be 1 nm, 1.2 μm, 4.5 μm, or 10 μm.

Optionally, the N-type thermocouple layer 402 has a thickness of 1 nm to 10.0 μm. In some exemplary embodiments, the thickness may be 1 nm, 1.0 μm, 5.0 μm, or 10 μm.

In another embodiment, a filler (not illustrated in the drawings) is located between the P-type thermocouple layer 401 and the N-type thermocouple layer 402, and in addition to the portion which forms the PN junction 403, the P-type thermocouple layer 401 and the N-type thermocouple layer 402 are isolated from each other by the filler.

A thickness and a height of the substrate 302 may be configured to adjust sensitivity of the thin-film thermopiles, such that the number of thin-film thermocouples 404 in the thin-film thermopile may be changed. The substrate 302 may be obtained by an edge folding process or a milling process.

In some embodiments, the substrate 302 and the heat dissipation housing 103 may be integrally molded, and the entire part may be obtained by the milling process. By integrally molding the heat dissipation housing 103 and the substrate 302, the parts desired for the heat dissipation housing 103 to be in thermal contact with a cold end of the substrate 302 may be reduced. In this way, the problem of a series of instabilities caused by thermal conduction between the heat dissipation housing 103 and the contact end of the substrate is addressed.

The laser power probing unit 101 is mounted inside the heat dissipation housing 103, a highly thermally conductive medium is added between the laser power probing unit 101 and the heat dissipation housing 103 to form the thermally conductive layer 102, and then by a leading and packaging process, a whole thermoelectric laser power probe is formed.

Due to presence of the passive region, generally, the thermoelectric laser power probe has a low response speed and a lower sensitivity. In addition, due to restriction of the traditional structure, the thermoelectric laser power probe generally has a large size, and is inconvenient to be integrated.

However, in the thermoelectric laser power probe 100 according to this embodiment, after the absorbent material layer 301 absorbs the laser and converts the laser energy into the heat, the heat is spread along the direction parallel to the laser incident direction. During spreading of the heat, an active region is decreased, and to some extent a potential transmission distance is shortened, such that a response speed of the probe is improved. In addition, the thin-film thermopiles are consistent with the laser incident direction, such that a cross section area of the probe in a probing surface direction is reduced, which facilitates miniaturization of the probe. In this way, the probe has a high flexibility, and may be integrated in various types of lasers for real-time monitoring of laser power, or may be integrated in a small or micro laser power meter or hand held.

### Second Embodiment

This embodiment is different from the first embodiment in that the thin-film thermopile in this embodiment is a multi-layer film structure, such that the thermoelectric laser power probe has a high sensitivity and a good linearity.

FIG. 5 is a schematic structural view of a thin-film thermopile according to an embodiment of the present disclosure. As illustrated in FIG. 5, each outer side surface of a substrate 501 is provided with an insulating layer 502, wherein the insulating layer 502 is provided with a thin-film thermopile 503 having a multi-layer film structure.

A P-type thermocouple layer 504, a first insulating thin-film layer 505, and an N-type thermocouple layer 506 are sequentially and repeatedly prepared on the insulating layer 502. A group of the P-type thermocouple layer 504, the first insulating thin-film layer 505, and the N-type thermocouple layer form a thin-film thermocouple 509 having a three-layer film structure. The P-type thermocouple layer 504 and the N-type thermocouple layer 506 are connected at one end of the first insulating thin-film layer 505 proximal to a top surface of the substrate 501 to form a PN junction 507. One end where the PN junction 507 is located is an operating end, and the other end opposite to the operating end is a reference end.

The thin-film thermopile 503 includes at least two thin-film thermocouples 509 having a three-layer film structure. Two adjacent thin-film thermocouples 509 are electrically connected in series by a connection junction 508. The connection junction 508 is located the reference end, and a second insulating thin-film layer 510 is located between the two adjacent thin-film thermocouples 509.

A positive electrode 511 of the thin-film thermopile 503 having a multi-layer film structure is led out from the reference end of the P-type thermocouple layer 504 of a first thin-film thermocouple 509 having a three-layer film structure, a negative electrode 512 of the thin-film thermopile 503 having a multi-layer film structure is led out from the reference end of the N-type thermocouple layer 505 of a last thin-film thermocouple 509 having a three-layer film structure, and output conductive wires 513 and 514 of the entire thin-film thermopile 503 are respectively led out from the positive electrode 511 and the negative electrode 512 by welding or contact connection.

The first insulating thin-film layer 505 and the second insulating thin-film layer 510 each include, but not limited to, a SiO₂ thin-film layer, an Al₂O₃ thin-film layer, or the like insulating thin-film layer.

For other details, reference may be made to the first embodiment, which are not descried herein any further.

### Third Embodiment

This embodiment is different from the above embodiments in that the laser power probing unit in this embodiment is a double-gate-shaped structure.

Referring to FIG. 6, FIG. 6 is a schematic structural view of a substrate of the laser power probing unit. Specifically, the substrate is a double-gate-shaped structure, and includes a horizontal top surface 601 and four outer side surfaces 602, 603, 604, and 605. The four outer side surfaces 602, 603, 604, and 605 are symmetrically arranged about a center axis O of the top surface 601, and each outer side surface is perpendicular to the top surface 601.

For other details, reference may be made to the first embodiment or the second embodiment, which are not descried herein any further.

### Fourth Embodiment

This embodiment is different from the above embodiments in that the laser power probing unit in this embodiment is an inverted-U-shaped structure.

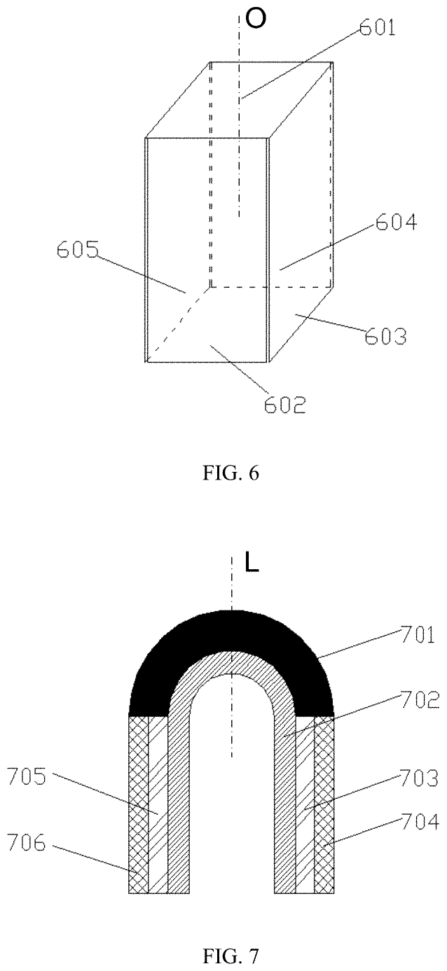

Referring to FIG. 7, FIG. 7 is a schematic structural sectional view of a laser power probing unit. Specifically, the substrate 702 is an inverted-U-shaped substrate, and includes a arc-shaped top surface and two outer side surfaces. The top surface is provided with an absorbent material layer 701. The absorbent material layer 701 corresponds to the light inlet 1301. The two outer side surfaces are symmetrically arranged about a center line L of a cross section of the top surface, and each of the outer side surfaces is perpendicular to a tangent plane of the arc-shaped top surface. One of the outer side surfaces is sequentially provided with a first insulating layer 703 and a thin-film thermopile 704, and the other of the outer side surfaces is sequentially provided with a second insulating layer 705 and a thin-film thermopile 706.

For other details, reference may be made to the first embodiment to the third embodiment, which are not descried herein any further.

### Fifth Embodiment

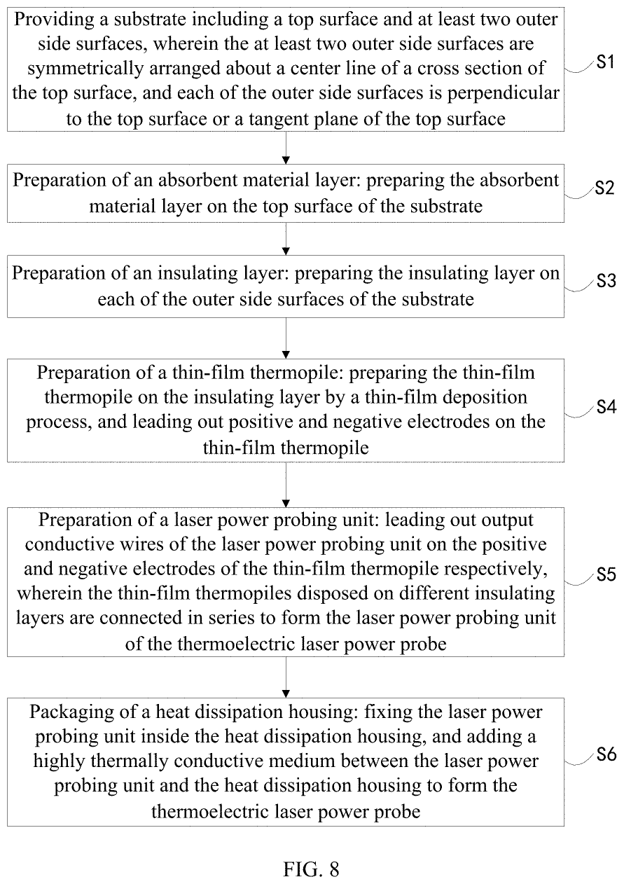

This embodiment provides a manufacturing method of the thermoelectric laser power probe as described above. Referring to FIG. 8, the method includes the following steps:

S1, providing a substrate including a top surface and at least two outer side surfaces, wherein the at least two outer side surfaces are symmetrically arranged about a center line of a cross section of the top surface, and each of the outer side surfaces is perpendicular to the top surface or a tangent plane of the top surface;

S2, preparation of an absorbent material layer: preparing the absorbent material layer on the top surface of the substrate;

S3, preparation of an insulating layer: preparing the insulating layer on each of the outer side surfaces of the substrate;

S4, preparation of a thin-film thermopile: preparing the thin-film thermopile on the insulating layer by a thin-film deposition process, and leading out positive and negative electrodes on the thin-film thermopile;

S5, preparation of a laser power probing unit: leading out output conductive wires of the laser power probing unit on the positive and negative electrodes of the thin-film thermopile respectively, wherein the thin-film thermopiles located on different insulating layers are connected in series to form the laser power probing unit of the thermoelectric laser power probe; and

S6, packaging of a heat dissipation housing: fixing the laser power probing unit inside the heat dissipation housing, and adding a highly thermally conductive medium between the laser power probing unit and the heat dissipation housing to form the thermoelectric laser power probe.

Preparing the thin-film thermopile on the insulating layer by a thin-film deposition process is the related art, which is not described herein any further. In addition, the structures of the thin-film thermopile and the absorbent material layer, and the connections and action fashions between the parts are the same as the first embodiment to the fourth embodiment, which are not described herein any further.

It should be noted that the specification and drawings of the present disclosure illustrate preferred embodiments of the present disclosure. However, the present disclosure may be implemented in different manners, and is not limited to the embodiments described in the specification. The embodiments described are not intended to limit the present disclosure, but are directed to rendering a thorough and comprehensive understanding of the disclosure of the present disclosure. In addition, the above described technical feature may incorporate and combine with each other to derive various embodiments not illustrated in the above specification, and such derived embodiments shall all be deemed as falling within the scope of the specification of the present disclosure. Further, a person skilled in the art may make improvements or variations according to the above description, and such improvements or variations shall all fall within the protection scope as defined by the claims of the present disclosure.

What is claimed is:

1. A thermoelectric laser power probe, comprising a heat dissipation housing and a laser power probing unit fixed inside the heat dissipation housing, the heat dissipation housing being provided with a light inlet; wherein
the laser power probing unit comprises a substrate, the substrate comprising a top surface and at least two outer side surfaces, the top surface being provided with an absorbent material layer, the absorbent material layer corresponding to the light inlet;
wherein the at least two outer side surfaces are symmetrically arranged about a center line of a cross section of the top surface, each of the outer side surfaces is perpendicular to the top surface or a tangent plane of the top surface, and each of the outer side surfaces is sequentially provided with an insulating layer and a thin-film thermopile;
the thin-film thermopile comprises at least two thin-film thermocouples, and two adjacent thin-film thermocouples are electrically connected by a connection junction, each of the thin-film thermocouples comprises a PN junction, the PN junction being located at one end proximal to the top surface of the substrate, the connection junction being located at the other end opposite to the top surface of the substrate, and one end where the PN junction is located is an operating end, one end where the connection junction is located is a reference end.

2. The thermoelectric laser power probe according to claim 1, wherein
each of the thin-film thermocouples comprises a P-type thermocouple layer and a N-type thermocouple layer, and the thermocouple layers connected by the connection junction are in different types, the P-type thermocouple layer and the N-type thermocouple layer being superimposed upon each other at one end proximal to the top surface of the substrate to form the PN junction; and
wherein a positive electrode of the thin-film thermopile is led out from the reference end of the P-type thermocouple layer of one outermost thin-film thermocouple, and a negative electrode of the thin-film thermopile is led out from the reference end of the N-type thermocouple layer of another outermost thin-film thermocouple.

3. The thermoelectric laser power probe according to claim 1, wherein
the thin-film thermopile is a multi-layer film structure, and comprises at least two thin-film thermocouples having a three-layer film structure, and a second insulating thin-film layer is located between the two adjacent thin-film thermocouples;
each of the thin-film thermocouples sequentially comprises a P-type thermocouple layer, a first insulating thin-film layer, and a N-type thermocouple layer, the P-type thermocouple layer and the N-type thermocouple layer being connected at one end of the first insulating thin-film layer proximal to the top surface of the substrate to form the PN junction;
wherein a positive electrode of the thin-film thermopile is led out from the reference end of the P-type thermocouple layer of a first thin-film thermocouple, and a negative electrode of the thin-film thermopile is led out from the reference end of the N-type thermocouple layer of a last thin-film thermocouple.

4. The thermoelectric laser power probe according to claim 1, wherein
the thin-film thermocouples located on different insulating layers are connected in series.

5. The thermoelectric laser power probe according to claim 2, wherein
the P-type thermocouple layer has a thickness of 1 nm to 10.0 μm; and
the N-type thermocouple layer has a thickness of 1 nm to 10.0 μm.

6. The thermoelectric laser power probe according to claim 3, wherein
the P-type thermocouple layer has a thickness of 1 nm to 10.0 μm; and
the N-type thermocouple layer has a thickness of 1 nm to 10.0 μm.

7. The thermoelectric laser power probe according to claim 1, wherein
the absorbent material layer comprises a surface absorbent material or a body absorbent material, and the absorbent material layer has a thickness of 1 nm to 3 mm.

8. The thermoelectric laser power probe according to claim 1, wherein
the substrate comprises a gate-shaped substrate, a double-gate-shaped substrate, or an inverted-U-shaped substrate;
wherein the gate-shaped substrate comprises a horizontal top surface and two outer side surfaces, the double-gate-shaped substrate comprises a horizontal top surface and four outer side surfaces, or the inverted-U-shaped substrate comprises an arc-shaped top surface and two outer side surfaces.

9. The thermoelectric laser power probe according to claim 8, wherein
the gate-shaped substrate, the double-gate-shaped substrate, or the inverted-U-shaped substrate is obtained by an edge folding process or a milling process.

10. The thermoelectric laser power probe according to claim 8, wherein
the gate-shaped substrate, the double-gate-shaped substrate, or the inverted-U-shaped substrate and the heat dissipation housing are integrally molded, and are obtained by a milling process.

11. A manufacturing method of a thermoelectric laser power probe, comprising the following steps:
S1, providing a substrate comprising a top surface and at least two outer side surfaces, wherein the at least two outer side surfaces are symmetrically arranged about a center line of a cross section of the top surface, and each of the outer side surfaces is perpendicular to the top surface or a tangent plane of the top surface;
S2, preparation of an absorbent material layer: preparing the absorbent material layer on the top surface of the substrate;
S3, preparation of an insulating layer: preparing the insulating layer on each of the outer side surfaces of the substrate;
S4, preparation of a thin-film thermopile: preparing the thin-film thermopile on the insulating layer by a thin-film deposition process, and leading out positive and negative electrodes on the thin-film thermopile, wherein the thin-film thermopile comprises at least two thin-film thermocouples, and two adjacent thin-film thermocouples are electrically connected by a connection junction, each of the thin-film thermocouples comprises a PN junction, the PN junction being located at one end proximal to the top surface of the substrate, the connection junction being located at the other end opposite to the top surface of the substrate, and one end where the PN junction is located is an operating end, one end where the connection junction is located is a reference end;
S5, preparation of a laser power probing unit: leading out output conductive wires of the laser power probing unit on the positive and negative electrodes of the thin-film thermopile respectively, wherein the thin-film thermopiles located on different insulating layers are connected in series to form the laser power probing unit of the thermoelectric laser power probe; and
S6, packaging of a heat dissipation housing: fixing the laser power probing unit inside the heat dissipation housing, and adding a highly thermally conductive medium between the laser power probing unit and the heat dissipation housing to form the thermoelectric laser power probe.

12. The manufacturing method of the thermoelectric laser power probe according to claim 11, wherein
each of the thin-film thermocouples comprises a P-type thermocouple layer and a N-type thermocouple layer, and the thermocouple layers connected by the connection junction are in different types, the P-type thermocouple layer and the N-type thermocouple layer being superimposed upon each other at one end proximal to the top surface of the substrate to form the PN junction; and
wherein a positive electrode of the thin-film thermopile is led out from the reference end of the P-type thermocouple layer of one outermost thin-film thermocouple, and a negative electrode of the thin-film thermopile is led out from the reference end of the N-type thermocouple layer of another outermost thin-film thermocouple.

13. The manufacturing method of the thermoelectric laser power probe according to claim 11, wherein
the thin-film thermopile is a multi-layer film structure, and comprises at least two thin-film thermocouples having a three-layer film structure, and a second insulating thin-film layer is located between the two adjacent thin-film thermocouples;
each of the thin-film thermocouples sequentially comprises a P-type thermocouple layer, a first insulating thin-film layer, and a N-type thermocouple layer, the P-type thermocouple layer and the N-type thermocouple layer being connected at one end of the first insulating thin-film layer proximal to the top surface of the substrate to form the PN junction;
wherein a positive electrode of the thin-film thermopile is led out from the reference end of the P-type thermocouple layer of a first thin-film thermocouple, and a negative electrode of the thin-film thermopile is led out from the reference end of the N-type thermocouple layer of a last thin-film thermocouple.

14. The manufacturing method of the thermoelectric laser power probe according to claim 12, wherein
the P-type thermocouple layer has a thickness of 1 nm to 10.0 μm; and
the N-type thermocouple layer has a thickness of 1 nm to 10.0 μm.

15. The manufacturing method of the thermoelectric laser power probe according to claim 13, wherein
the P-type thermocouple layer has a thickness of 1 nm to 10.0 μm; and
the N-type thermocouple layer has a thickness of 1 nm to 10.0 μm.

16. The manufacturing method of the thermoelectric laser power probe according to claim 11, wherein
the absorbent material layer comprises a surface absorbent material or a body absorbent material, and the absorbent material layer has a thickness of 1 nm to 3 mm.

17. The manufacturing method of the thermoelectric laser power probe according to claim 11, wherein
the substrate comprises a gate-shaped substrate, a double-gate-shaped substrate, or an inverted-U-shaped substrate;
wherein the gate-shaped substrate comprises a horizontal top surface and two outer side surfaces, the double-gate-shaped substrate comprises a horizontal top surface and four outer side surfaces, or the inverted-U-shaped substrate comprises an arc-shaped top surface and two outer side surfaces.

18. The manufacturing method of the thermoelectric laser power probe according to claim 17, wherein
the gate-shaped substrate, the double-gate-shaped substrate, or the inverted-U-shaped substrate is obtained by an edge folding process or a milling process.

19. The manufacturing method of the thermoelectric laser power probe according to claim 17, wherein
the gate-shaped substrate, the double-gate-shaped substrate, or the inverted-U-shaped substrate and the heat dissipation housing are integrally molded, and are obtained by a milling process.
